(19) United States
(12) Patent Application Publication
(10) Pub. No.: US 2012/0229042 A1
(43) Pub. Date: Sep. 13, 2012

(54) INVERTER FOR CONTROLLING BACKLIGHT USING VARIABLE FREQUENCY OSCILLATOR

(75) Inventor: Yu Jin JANG, Suwon (KR)

(73) Assignee: SAMSUNG ELECTRO-MECHANICS CO., LTD.

(21) Appl. No.: 13/212,836

(22) Filed: Aug. 18, 2011

(30) Foreign Application Priority Data
Mar. 9, 2011 (KR) 10-2011-0021076

(51) Int. Cl. H05B 37/02

(52) U.S. Cl. 315/205; 315/224

(57) ABSTRACT

There is provided an inverter for controlling a backlight using a variable frequency oscillator, the inverter including: a variable frequency oscillator generating a reference waveform having a variable frequency through voltage charged in a first capacitor and voltage discharged therefrom by a current; and a main switching signal generator generating a switching signal for driving a plurality of lamps based on a first error voltage between output voltages corresponding to currents flowing in the lamps and a first reference voltage and the reference waveform, whereby damage of circuit elements such as the lamps, or the like, may be prevented and the brightness of the lamps may be constantly maintained.

### CROSS-REFERENCE TO RELATED APPLICATIONS

This application claims the priority of Korean Patent Application No. 10-2011-0021076 filed on Mar. 9, 2011, in the Korean Intellectual Property Office, the disclosure of which is incorporated herein by reference.

### BACKGROUND OF THE INVENTION

1. Field of the Invention

The present invention relates to an inverter for controlling a backlight, and more particularly, to an inverter for controlling a backlight using a variable frequency oscillator for constantly maintaining the brightness of a lamp.

2. Description of the Related Art

Generally, since a liquid crystal display device may not emit light by itself, it employs a backlight on a rear surface thereof to irradiate light through the front surface of the liquid crystal display device. As a backlight for a large liquid crystal display device, a cold cathode fluorescent lamp (CCFL) has been mainly used to date. An inverter is required in order to drive such a cold cathode fluorescent lamp.

In addition, when a lamp used in the backlight of the liquid crystal display device is driven, it is important to constantly maintain the brightness of the lamp according to various characteristics of the lamp. To this end, the inverter includes a feedback circuit feeding back a current of the lamp to thereby maintain the current of the lamp to be constant. Further, in the inverter for driving the backlight of the liquid crystal display device, a protective circuit function capable of protecting the device is very important. Particularly, in a multi-lamp driving inverter, a function of recognizing the opening of the lamp so as to protect the device is one of main functions thereof.

The backlight inverter of the liquid crystal display device according to the related art has driven the lamp at a constant frequency without considering the characteristics of the lamp in terms of aging, high temperature, cooling, damage, and the like, such that in the case in which the characteristics of the lamp are changed, the brightness of the lamp may not be constantly maintained. In addition, when the lamp is opened, it is operated at an excessively high frequency by a protective circuit, such that heat may be generated in a transformer.

### SUMMARY OF THE INVENTION

An aspect of the present invention provides an inverter for controlling a backlight capable of reducing heat generation in a transformer while maintaining the brightness of a lamp to be constant.

According to an aspect of the present invention, there is provided an inverter for controlling a backlight, the inverter including: a variable frequency oscillator generating a reference waveform having a frequency varied according to characteristics of lamps; and a main switching signal generator generating a main switching signal for driving the lamps from the reference waveform generated by the variable frequency oscillator and a first error voltage based on output voltages corresponding to currents flowing in the lamps.

The variable frequency oscillator may include: a first capacitor; a first current generating module generating a constant first current; and a second current generating module generating a second current varied according to the characteristics of the lamps, and may generate by charging and discharging of a voltage to and from the first capacitor by the first current generated by the first current generating module and generate the reference waveform by charging and discharging of the voltage to and from the first capacitor by a sum current of the first current and the second current when an enable signal for considering the characteristics of the lamps is input.

The inverter may further include a protective signal generator generating a protective signal for determining whether or not the lamps are opened, based on the output voltages corresponding to the currents flowing in the lamps.

The variable frequency oscillator may further include a third current generating module generating a constant third current according to the protective signal generated by the protective signal generator, and may generate the reference waveform by charging and discharging of the voltage to and from the first capacitor by a sum current of the first current and the third current when the protective signal is input.

The main switching signal generator may include: rectifiers rectifying the output voltages corresponding to the currents flowing in the lamps; a voltage distributor dropping the output voltages rectified by the rectifier to a low level voltage; a first operational tansconductance amplifier (OTA) generating a current in proportion to a difference between the voltage dropped by the voltage distributor and a constant first reference voltage; a second capacitor generating the first error voltage based on the current generated by the first operational transconductance amplifier; and a first comparator generating the main switching signal based on a comparison result between the first error voltage and the reference waveform.

The second current generating module may include a second operational transconductance amplifier generating a current in proportion to a difference between the first error voltage and a constant second reference voltage.

The second current generating module may further include a diode connected to an output terminal of the second operational transconductance amplifier and preventing a backward flow of the current.

The protective signal generator may include: rectifiers rectifying the output voltages corresponding to the currents flowing in the lamps; RC filters filtering the rectified output voltages; and a second comparator generating the protective signal based on the filtered output voltages and a constant second comparative voltage.

The protective signal generator may further include voltage followers connected to input terminals of the rectifiers.

The reference waveform may include a triangular wave.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing the configuration of a system including an inverter for controlling a backlight according to an exemplary embodiment of the present invention;

FIG. 2 is a view showing the configuration of an inverter for controlling a backlight according to an exemplary embodiment of the present invention; and

FIG. 3 is a view showing waveforms of main parts of an inverter for controlling a backlight according to an exemplary embodiment of the present invention.

### DETAILED DESCRIPTION OF THE PREFERRED EMBODIMENT

Exemplary embodiments of the present invention will be described with reference to the accompanying drawings. The exemplary embodiments of the present invention may be modified in many different forms and the scope of the invention should not be seen as being limited to the embodiments set forth herein. Rather, these embodiments are provided so that this disclosure will be thorough and complete, and will fully convey the concept of the invention to those skilled in the art. Therefore, it is to be noted that the shapes and sizes of components shown in the drawings may be exaggerated for clarity of description.

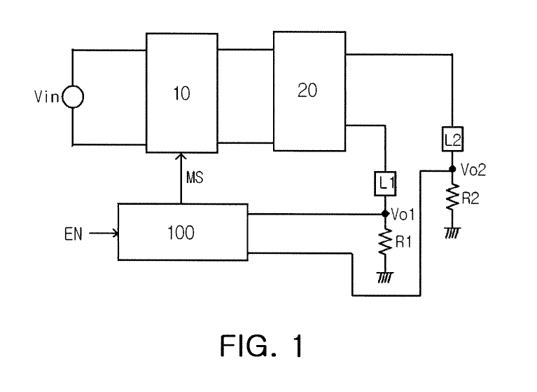

FIG. 1 is a view showing the configuration of a system including an inverter for controlling a backlight according to an exemplary embodiment of the present invention.

Referring to FIG. 1, cold cathode fluorescent lamps (CCFLs) L1 and L2 are light sources for a liquid crystal display device generating visible rays through electrons emitted by a voltage supplied from the outside. The CCFLs L1 and L2 are used as light sources of a backlight of a thin film transistor liquid crystal display (TFT-LCD) used in a monitor, a television, a notebook, or the like, or in a facsimile, a scanner, a copy machine, a decorative device, and the like. These CCFLs may generate various colors of emitted light through the changing of the mixing ratio of red, blue, and green fluorescent materials, and have characteristics such as low power consumption and strong resistance to vibrations or impacts.

An inverter 100 for controlling a backlight receives feedbacks of voltages Vo1 and Vo2, corresponding to currents flowing through resistors R1 and R2 connected to the CCFLs L1 and L2, and generates a main switching signal MS to thereby transfer the generated main switching signal to a main switching module 10.

The main switching module 10 controls a plurality of switching elements according to the main switching signal MS transferred from the inverter 100 for controlling a backlight.

Meanwhile, a transformer module 20 is connected to the main switching module 10 and converts an input power Vin into a power for driving the CCFLs L1 and L2 to thereby supply the converted power to the CCFLs L1 and L2. Hereinafter, the inverter 100 for controlling a backlight according to an exemplary embodiment of the present invention will be described in detail.

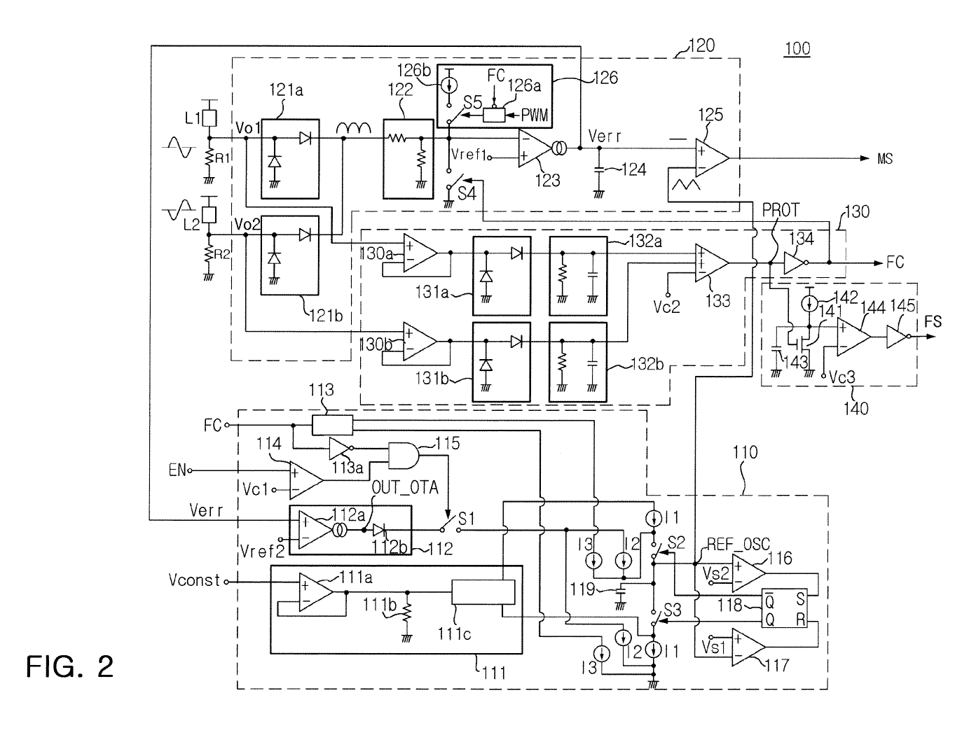

FIG. 2 is a view showing the configuration of the inverter 100 for controlling a backlight according to the exemplary embodiment of the present invention. The inverter 100 for controlling a backlight according to the exemplary embodiment of the present invention may include a variable frequency oscillator 110, a main switching signal generator 120, a protective signal generator 130, and a delay signal generator 140.

Referring to FIG. 2, the variable frequency oscillator 110 generates a reference waveform REF_OSC having a variable frequency through voltage charged in a capacitor 119 and voltage discharged therefrom by currents I1, I2, and I3, and transfers the generated reference waveform REF_OSC to the main switching signal generator 120. The main switching signal generator 120 compares the reference waveform REF_OSC having the variable frequency with an error voltage Verr to thereby generate a main switching signal MS for driving lamps L1 and L2. The reference waveform may include a triangular wave.

More specifically, the variable frequency oscillator 110 may include the capacitor 119, a first current generating module 111 generating two first currents I1 having a constant magnitude based on an input voltage Vconst, a second current generating module 112 generating two second currents I2 having a variable magnitude based on the error voltage Verr, and a third current generating module 113 generating two third currents I3 having a constant magnitude based on a protective signal PROT.

The first current generating module 111 may include a voltage follower 111a receiving the input voltage Vconst, a resistor 111b connected between an output terminal of the voltage follower 111a and a ground, and a first current generator 111c connected to the output terminal of the voltage follower 111a to thereby generate the two first currents I1 in proportion to the input voltage Vconst. The first current generator 111c may be configured of, for example, a current mirror circuit.

The second current generating module 112 may include an operational transconductance amplifier (OTA) 112a receiving the error voltage Verr in a positive (+) terminal thereof and a reference voltage Vref2 in a negative (−) terminal thereof, and a diode 112b connected to an output terminal of the operational transconductance amplifier (OTA) 112a. Here, the reference voltage Vref2 indicates a voltage preset in order to vary a frequency of the main switching signal MS according to a change in loads L1 and L2.

Meanwhile, the third current generating module 113 is a circuit receiving a frequency control signal FC, which is an inverted signal of the protective signal PROT, to thereby generate the two third currents I3 having the same preset magnitude. The third current generating module 113 may also be configured of a current mirror circuit. Meanwhile, in the embodiment of the present invention, reference signs I1, I2, and I3 indicate respective currents output from the current generating modules 111, 112, and 113 rather than independent current sources.

An input terminal of the third current generating module 113 is connected to an AND gate 115 through an inverter 113a. In addition, an enable signal EN is input to a positive (+) terminal of a comparator 114, a comparative voltage Vc1 is input to a negative (−) terminal of the comparator 114, an output of the comparator 114 is input to another input terminal of the AND gate 115. Further, an output terminal of the second current generating module 112 has a switch S1 connected thereto, wherein the switch S1 is controlled by a signal output from the AND gate 115. Here, the enable signal EN indicates a signal applied from the outside in order to generate a frequency of the main switching signal MS variable according to the characteristics of the lamps L1 and L2. Meanwhile, the comparative voltage Vc1, which is a reference voltage compared with the enable signal EN, is preset to have a predetermined magnitude.

The respective currents I1, I2, and I3 are connected in parallel. Through two complementarily operating switches S2 and S3, upper side currents I1, I2, and I3 allow a voltage to be charged in the capacitor 119, and lower side currents I1, I2, and I3 allow the voltage charged in the capacitor 119 to be discharged therefrom. The complementary switching operation of the two switches S2 and S3 is performed through an SR latch 118 and two comparators 116 and 117. A positive (+) terminal of the comparator 116 has a reference waveform REF_OSC input thereto, and a negative (−) terminal thereof has a second set voltage Vs2 input thereto. Also, a positive (+) terminal of the comparator 117 has a first set voltage Vs1 input thereto, and a negative (−) terminal thereof has the reference waveform REF_OSC input thereto. The charging and discharging of the voltage charged in the capacitor 119 is performed between the first set voltage Vs1 and the second set voltage Vs2, whereby the reference waveform REF_OSC for generating the main switching signal MS may be generated.

Meanwhile, the main switching signal generator 120 generates the main switching signal MS for driving the lamps based on an error voltage Verr between output voltages Vo1 and Vo2 corresponding to currents flowing in the plurality of lamps L1 and L2 and a reference voltage Vref1 and the reference waveform REF_OSC. Here, the reference voltage Vref1 indicates a voltage used to compare with the output voltage reduced in order to generate the error voltage Verr.

More specifically, the main switching signal generator 120 may include rectifiers 121a and 121b respectively rectifying the output voltages Vo1 and Vo2 corresponding to the currents flowing in the plurality of lamps, a voltage distributor 122 configured of resistors for distributing the rectified output voltages Vo1 and Vo2 to a low level of voltage, an operational transconductance amplifier (OTA) 123 generating a current in proportion to a difference between the voltage distributed by the voltage distributor 122 and the reference voltage Vref1, a switch S4 having one end connected to an output of the voltage distributor 122 and a negative (−) terminal of the operational transconductance amplifier 123 and the other end connected to a ground to thereby be open or closed by the inverted signal (that is, the frequency control signal FC) of the protective signal PROT, a capacitor 124 generating the error voltage Verr based on the current generated by the operational transconductance amplifier 123, and a comparator 125 generating the main switching signal MS based on a comparison result between the error voltage Verr and the reference waveform REF_OSC.

Additionally, the main switching signal generator 120 may further include a dimming control block 126. More specifically, the dimming control block 126 includes a current source 126b, and a switch S5 having one end connected to the current source 126 and the other end connected to the voltage distributor 122 and the negative (−) terminal of the operational transconductance amplifier 123. The switch S5 is opened or closed by a control signal of a dimming controller 126 based on an pulse width modulation (PWM) signal applied from the outside.

The protective signal generator 130 generates the protective signal PROT for determining the damage of the lamps based on the output voltages Vo1 and Vo2 corresponding to the currents flowing in a portion of the plurality of lamps L1 and L2. The generated protective signal PROT is transferred to the delay signal generator 140. In addition, the generated protective signal PROT is inverted by an inverter 134 and is then transferred to the main switching signal generator 120.

More specifically, the protective signal generator 130 may include voltage followers 130a and 130b receiving and outputting the output voltages Vo1 and Vo2 corresponding to the currents flowing in the plurality of lamps L1 and L2, rectifiers 131a and 131b rectifying the voltages output from the voltage followers 130a and 130b, RC filters 132a and 132b filtering the rectified output voltages, a comparator 133 generating the protective signal PROT based on a comparison result between the filtered output voltages and a comparative voltage Vc2, and the inverter 134 inverting the protective signal PROT. The inverted signal of the protective signal PROT becomes the frequency control signal FC.

Meanwhile, the delay signal generator 140 generates a delay signal by delaying the protective signal PROT for a predetermined period of time. More specifically, the delay signal generator 140 may include a current source 142, a switch 141 having one end connected to the current source 142 and the other end connected to a ground and opened or closed by the protective signal PROT, a capacitor 143 connected between one end of the switch 141 and the ground, a comparator 144 having a positive (+) terminal connected to the capacitor 143 and a negative (−) terminal having a comparative voltage Vc3 applied thereto, and an inverter 145 connected to an output terminal of the comparator 144. Here, the comparative voltage Vc3 indicates a reference voltage for controlling a delay degree of the protective signal PROT.

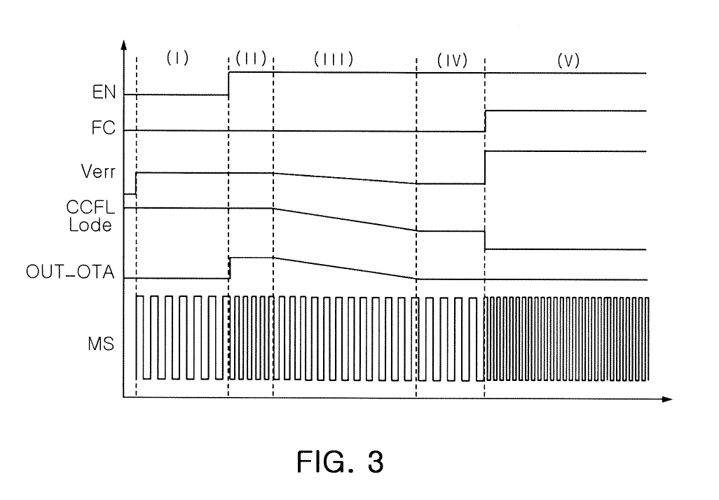

Hereinafter, the operation and effect of the present invention will be described in detail with reference to the accompanying drawings, particularly, FIGS. 2 and 3.

Referring to FIGS. 2 and 3, period I indicates a period in which the lamps L1 and L2 are driven by a main switching signal MS having a frequency in proportion to only a constant input power Vconst. Therefore, the lamps L1 and L2 are driven at the constant frequency of the main switching signal MS regardless of the characteristics of the lamps L1 and L2. Since the frequency of the main switching signal MS is always constant as described above, the characteristics of the lamps L1 and L2 are not considered. Therefore, in the case in which the characteristics of the lamps are changed, the brightness of the lamps may not be constantly maintained.

Describing period I in more detail, a constant input voltage Vconst is input to the first current generating module 111, and two first currents I1 in proportion to the input voltage Vconst are mirrored by the first current generator 111c. The two mirrored first currents I1 allow a voltage to be charged in the capacitor 119 and discharged therefrom between the first set voltage Vs1 and the second set voltage Vs2 by the two complementarily operating switches S2 and S3, whereby a reference waveform REF_OSC having a constant frequency is generated. The generated reference waveform REF_OSC is compared with an error voltage Verr in the comparator 125, whereby the main switching signal MS may be generated.

Hereinafter, a process of generating the reference waveform REF_OSC by the two mirrored first currents I1 will be described in detail. When the switch S2 is turned on, the voltage is charged in the capacitor 119 by upper side first current I1. The voltage charged in the capacitor 119 is input to the positive (+) terminal of the comparator 116, and a preset second set voltage Vs2 is input to the negative (−) terminal thereof. As soon as the voltage charged in the capacitor 119 exceeds to the second set voltage Vs2, a high (H) signal is output from the comparator 116, and is then input to an S terminal of the SR latch 118. At this time, a high (H) signal is output from a Q terminal of the SR latch 118, and the switch S3 is turned on by the output high (H) signal.

Meanwhile, a low (L) signal is output from a Q̅ terminal of the SR latch 118, and the switch S2 is turned off by the output low (L) signal. Therefore, the voltage charged in the capacitor 119 starts to be discharged therefrom by lower side first current I1. Meanwhile, the voltage of the capacitor 119 is input to the negative (−) terminal of the comparator 117, and a preset first set voltage Vs1 is input to the positive (+) terminal thereof. As soon as the voltage of the capacitor 119 decreases to the first set voltage Vs1 or less, a high (H) signal is output from the comparator 117 and is then input to an R terminal of the SR latch 118.

At this time, a low (L) signal is output from the Q terminal of the SR latch 118, and the switch S3 is turned off by the output low (L) signal. A high (H) signal is output from the Q̅ terminal of the SR latch 118, and the switch S2 is turned on by the output high (H) signal. Therefore, the voltage starts to again be charged in the capacitor 119. As a result, the voltage is repetitively charged in the capacitor 119 and discharged therefrom between the first set voltage Vs1 and the second set voltage Vs2 by the two first currents I1 having the same magnitude, whereby the reference waveform REF_OSC having a constant frequency in proportion to the first current I1 is generated. The generated reference waveform REF_OSC is input to the negative (−) terminal of the comparator 125 of the main switching signal generator 120 and is compared with the error voltage Verr input to the positive (+) terminal of the comparator 125, whereby the main switching signal Ms is generated.

Meanwhile, in period I, the second and third current generating modules 112 and 113 do not operate. That is, since an enable signal EN is a low (L) signal, it is lower than a comparative voltage Vc1 (for example, 2.4V), such that an output of the comparator 114 is a low (L) signal. Therefore, an output of the AND gate 115 becomes a low (L) signal, such the switch S1 is turned off. The frequency control signal FC is also a low (L) signal, such that the third current generating module 113 also does not operate. As a result, in period I, the voltage is charged in the capacitor 119 and discharged therefrom by the first current I1 having a constant magnitude only in proportion to the input voltage Vconst, regardless of the characteristics of the lamp, whereby the reference waveform REF_OSC having a constant frequency and the main switching signal MS are generated.

Periods II to IV indicate periods in which a frequency of the main switching signal MS is varied in order to reflect the characteristics of the lamps L1 and L2. Here, the characteristics of the lamp indicate a change in a (lamp) load according to cooling, temperature, aging, or the like, of the lamp. That is, the above-mentioned periods are initiated by the enable signal EN applied from the outside. In period II, the error voltage Verr is reflected, such that the frequency of the main switching signal MS is temporarily increased. However, as the load CCFL LOAD L1 and L2 are gradually reduced to thereby be stabilized, the frequency of the main switching signal MS is reduced in period IV. As described above, the frequency of the main switching signal MS is varied according to the loads L1 and L2, whereby the brightness of the lamps L1 and L2 may be constantly maintained. Hereinafter, each of periods II to IV will be described in detail.

In period II, the enable signal EN is applied from the outside, such that the second current generating module 112 operates. Hereinafter, a process of generating the main switching signal MS in period II will be described in more detail.

When the enable signal EN is input to the positive (+) terminal of the comparator 114, the input enable signal EN is compared with the comparative voltage Vc1 (for example, 2.4V) input to the negative (−) terminal thereof. Since the enable signal EN is a high (H) signal, a high (H) signal is output from the comparator 114. The output high (H) signal is input to the AND gate 115. Meanwhile, since the frequency control signal FC is a low (L) signal, a high (H) signal inverted by the inverter 113a is input to the AND gate 115. A high (H) signal is output from the AND gate 115 by an AND operation by the AND gate 115. The switch S1 is turned on by the output high (H) signal, whereby the second current I2 output from the second current generating module 112 is summed up to the first current I1.

Meanwhile, the error voltage Verr is input to the positive (+) terminal of the operational transconductance amplifier (OTA) 112a of the second current generating module 112, and the reference voltage Vref2 is input to the negative (−) terminal thereof. The second current I2, in proportion to a difference between the error voltage Verr and the reference voltage Vref2, is generated by the operational transconductance amplifier (OTA) 112a, and is then output through the diode 112b to thereby be summed up to the first current I1. Then, when the switch S2 is turned on, the voltage is charged in the capacitor 119 by the sum current I1+I2. Thereafter, the reference waveform REF_OSC is generated by an operational principle as described in detail in period I.

The generated reference waveform REF_OSC is input to the negative (−) terminal of the comparator 125 of the main switching signal generator 120 to be compared with the error voltage Verr input to the positive (+) terminal of the comparator 125, whereby the main switching signal Ms is generated. Meanwhile, the frequency of the generated reference waveform REF_OSC may be in proportion to the magnitude of the sum current I1+I2, and may be generally 1.1 times the frequency in period I. According to the exemplary embodiment of the present invention, the diode 112b is disposed at the output terminal of the operational transconductance amplifier (OTA) 112a, whereby backward flow of the current may be prevented.

Period III indicates a period in which the load L1 and L2 are gradually stabilized by the main switching signal MS applied in the above-mentioned period II. Therefore, the loads L1 and L2 are gradually reduced, such that the frequency of the main switching signal MS is gradually reduced.

More specifically, the error voltage Verr is input to the positive (+) terminal of the operational transconductance amplifier (OTA) 112a of the second current generating module 112, and the reference voltage Vref2 is input to the negative (−) terminal thereof. The second current I2, in proportion to a difference between the error voltage Verr and the reference voltage Vref2, is generated by the operational transconductance amplifier (OTA) 112a, and is then output through the diode 112b to thereby be summed up to the first current I1. Then, when the switch S2 is turned on, the voltage is charged in the capacitor 119 by the sum current I1+I2. Thereafter, the reference waveform REF_OSC is generated by an operational principle as described in detail in period I. The generated reference waveform REF_OSC is input to the negative (−) terminal of the comparator 125 of the main switching signal generator 120 and is compared with the error voltage Verr input to the positive (+) terminal of the comparator 125, whereby the main switching signal Ms is generated. Meanwhile, as the loads L1 and L2 are reduced, the frequency of the main switching signal MS in period III is gradually reduced from 1.1 times to 1 time of the frequency in period I.

Period IV indicates a period in which the loads L1 and L2 are completely stabilized. More specifically, the error voltage Verr becomes the reference voltage Vref2 or less, such that the output from the operational transconductance amplifier (OTA) 112a becomes 0. As a result, the second current I2 also becomes 0. In period IV, the capacitor 119 generates the reference waveform REF_OSC having the same frequency as that in period I. The generated reference waveform REF_OSC is input to the negative (−) terminal of the comparator 125 of the main switching signal generator 120 and is compared with the error voltage Verr input to the positive (+) terminal of the comparator 125, whereby the main switching signal Ms is generated.

Period V indicates a period in which the frequency of the main switching signal MS is increased to a preset frequency (which is 1.5 times the frequency in period I) according to the protective signal PROT sensing the opening of the lamps L1 and L2. In this period, there is a need to limit the operation of the second current generating module 112 by the error voltage Verr so that the frequency of the main switching signal MS is not excessively increased. As described above, when the lamps L1 and L2 are opened, the frequency of the main switching signal MS is increased to a preset maximum frequency, whereby the heat generation of a transformer may be reduced while the brightness of the lamp is constantly maintained. Hereinafter, period V will be described.

When at least one of the lamps L1 and L2 is opened, a voltage input to at least one of the positive (+) terminals of the comparator 133 is reduced to the comparative voltage Vc2 or less input to the negative (−) terminal thereof, such that the output (that is, the protective signal PROT) of the comparator 133 becomes a low (L) signal. The protective signal PROT, which is a low (L) signal, is inverted by the inverter 134 to thereby become the frequency control signal FC, which is a high (H) signal. The frequency control signal FC is output to the third current generating module 113 simultaneously with output to the switch S4.

A constant third current I3 is output from the third current generating module 113 according to the frequency control signal FC input to the third current generating module 113. Then, as described in period I, the voltage is charged in the capacitor 119 and discharged therefrom by the sum current of the first current I1 and the third current I3, whereby the reference waveform REF_OSC is generated. The generated reference waveform REF_OSC is input to the negative (−) terminal of the comparator 125 of the main switching signal generator 120 and is compared with the error voltage Verr input to the positive (+) terminal of the comparator 125, whereby the main switching signal Ms is generated. Meanwhile, the frequency of the main switching signal MS in period V may be set to be about 1.5 times the frequency in period I.

Meanwhile, the switch S4 is turned on by the frequency control signal FC, such that the error voltage Verr has a maximum value. However, the error voltage Verr does not have an influence on the frequency of the main switching signal MS as described below. That is, there is a need to limit the operation of the second current generating module 112 so that the frequency of the main switching signal MS is not excessively increased in period V. The protective signal PROT becomes a low (L) signal inverted two times by the inverter 134 and the inverter 113a to thereby be input to a terminal of the AND gate 115. Therefore, the output of the AND gate 115 becomes a low (L) signal regardless of the output of the comparator 114, such that the switch S1 is always turned off and the second current I2 does not have an influence on the frequency of the main switching signal MS. As described above, in the case in which the lamps L1 and L2 are opened, an excessive increase of the frequency of the main switching signal MS is prevented, whereby the heat generation problem of the transformer may be solved.

In addition, according to the exemplary embodiment of the present invention, the inverter 100 for controlling a backlight may further include the delay signal generator 140 delaying and outputting the protective signal PROT in the case that the lamp (at least one of L1 and L2) is opened. More specifically, when the protective signal PROT becomes a low (L) signal, the switch 141 of the delay signal generator 140 is turned off, such that the voltage is charged in the capacitor 143 by a current from the current source 142. When the voltage charged in the capacitor 143 becomes the comparative voltage Vc3 or more, an output signal of the comparator 144 becomes a high (H) signal. The high (H) signal may be inverted by the inverter 145 to thereby be output to the outside.

Meanwhile, according to the exemplary embodiment of the present invention, an operation of the dimming control block 126 may be stopped according to the frequency control signal FC. More specifically, the switch S5 is turned off according to the frequency control signal FC to disconnect the current source 126b, whereby the dimming control by an external PWM control signal may not be performed. As a result, the lamps L1 and L2 may be driven at a higher current.

As set forth above, according to the exemplary embodiments of the present invention, the lamp is driven by a main switching signal having a variable frequency according to characteristics of the lamp, and is driven by a main switching signal having a preset maximum frequency in the case in which the lamp is opened, whereby heat generation of the transformer may be reduced while the brightness of the lamp is constantly maintained.

The exemplary embodiments of the present invention have been described with reference to the accompanying drawings. Herein, specific terms have merely been used for the purpose of describing the present invention and have not been used for qualifying the meaning or limiting the scope of the present invention, which is disclosed in the appended claims. Therefore, it will be appreciated to those skilled in the art that various modifications can be made and other equivalent embodiments may be available. Accordingly, the actual technical protection scope of the present invention must be determined by the scope of the appended claims.

What is claimed is:

1. An inverter for controlling a backlight, the inverter comprising:
a variable frequency oscillator generating a reference waveform having a frequency varied according to characteristics of lamps; and
a main switching signal generator generating a main switching signal for driving the lamps from the reference waveform generated by the variable frequency oscillator and a first error voltage based on output voltages corresponding to currents flowing in the lamps.

2. The inverter of claim 1, wherein the variable frequency oscillator includes:
a first capacitor;
a first current generating module generating a constant first current; and
a second current generating module generating a second current varied according to the characteristics of the lamps, and
the variable frequency oscillator generates the reference waveform by charging and discharging of a voltage to and from the first capacitor by the first current generated by the first current generating module, and generates the reference waveform by charging and discharging of the voltage to and from the first capacitor by a sum current of the first current and the second current when an enable signal for considering the characteristics of the lamps is input.

3. The inverter of claim 1, further comprising a protective signal generator generating a protective signal for determining whether or not the lamps are opened, based on the output voltages corresponding to the currents flowing in the lamps.

4. The inverter of claim 2, wherein the variable frequency oscillator further includes a third current generating module generating a constant third current according to the protective signal generated by the protective signal generator, and
the variable frequency oscillator generates the reference waveform by charging and discharging of the voltage to and from the first capacitor by a sum current of the first current and the third current when the protective signal is input.

5. The inverter of claim 1, wherein the main switching signal generator includes:
rectifiers rectifying the output voltages corresponding to the currents flowing in the lamps;
a voltage distributor dropping the output voltages rectified by the rectifiers to a low level voltage;
a first operational tansconductance amplifier (OTA) generating a current in proportion to a difference between the voltage dropped by the voltage distributor and a constant first reference voltage;
a second capacitor generating the first error voltage based on the current generated by the first operational transconductance amplifier; and
a first comparator generating the main switching signal based on a comparison result between the first error voltage and the reference waveform.

6. The inverter of claim 2, wherein the second current generating module includes a second operational transconductance amplifier generating a current in proportion to a difference between the first error voltage and a constant second reference voltage.

7. The inverter of claim 6, wherein the second current generating module further includes a diode connected to an output terminal of the second operational transconductance amplifier and preventing a backward flow of the current.

8. The inverter of claim 3, wherein the protective signal generator includes:
rectifiers rectifying the output voltages corresponding to the currents flowing in the lamps;
RC filters filtering the rectified output voltages; and
a second comparator generating the protective signal based on the filtered output voltages and a constant second comparative voltage.

9. The inverter of claim 8, wherein the protective signal generator further includes voltage followers connected to input terminals of the rectifiers.

10. The inverter of claim 1, wherein the reference waveform includes a triangular wave.
